(19) United States
(12) Patent Application Publication
(10) Pub. No.: US 2023/0401183 A1
(43) Pub. Date: Dec. 14, 2023

(54) DATA DRIFT DETECTION BETWEEN DATA STORAGE

(71) Applicant: Intuit Inc., Mountain View, CA (US)

(72) Inventors: Raymond Chan, San Diego, CA (US); Suresh Muthu, Mountain View, CA (US)

(73) Assignee: Intuit Inc., Mountain View, CA (US)

(21) Appl. No.: 17/829,331

(22) Filed: May 31, 2022

(51) Int. Cl. G06F 16/215; G06F 16/27; G06F 16/25; G06F 11/08

(52) U.S. Cl. CPC G06F 16/215; G06F 11/08; G06F 16/258; G06F 16/27

(57) ABSTRACT

A method for detecting data drift between a first database and a second database involves obtaining (from the first database) and based on a change data capture (CDC) event generated in response to a change detected in the first database, a first record identified by the CDC event, obtaining (from the second database) a second record corresponding to the first record, transforming a data structure of the first record from the first database to the data structure of the second database generating a transformed record, and based on determining that a difference between the first record and a second record exists, reporting a presence of data drift.

### BACKGROUND

Organizations that use data storage (e.g., databases, data warehouses, data lakes) may need to keep the content of the data storage synchronized. Various scenarios may require synchronization. For example, synchronization may be necessary when multiple data storage environments are used to establish redundancy. A synchronization may also be necessary when a migration is performed from one type of data storage to another type of data storage. A data drift between the data storages may occur and may have undesirable consequences. For these and other reasons, discussed below, detecting data drift may be desirable.

### SUMMARY

In one aspect, a method for detecting data drift between a first database and a second database, comprising obtaining, from the first database, and based on a change data capture (CDC) event generated in response to a change detected in the first database, a first record identified by the CDC event; obtaining, from the second database, a second record corresponding to the first record; transforming a data structure of the first record from the first database to the data structure of the second database generating a transformed record; and based on determining that a difference between the first record and a second record exists: reporting a presence of data drift.

In one aspect, a system for detecting data drift detection, comprising: computer processor; and a data drift detection engine executing on the computer processor configured to: obtain, from the first database, and based on a change data capture (CDC) event generated in response to a change detected in the first database, a first record identified by the CDC event; obtain, from the second database, a second record corresponding to the first record; transform a data structure of the first record from the first database to the data structure of the second database generating a transformed record; based on determining that a difference between the first record and a second record exists: report a presence of data drift.

In one aspect, a non-transitory computer readable medium comprising instruction for execution on a computer processor to perform: obtaining, from the first database, and based on a change data capture (CDC) event generated in response to a change detected in the first database, a first record identified by the CDC event; obtaining, from the second database, a second record corresponding to the first record; transforming a data structure of the first record from the first database to the data structure of the second database generating a transformed record; and based on determining that a difference between the first record and a second record exists: reporting a presence of data drift.

Other aspects of the invention will be apparent from the following description and the appended claims.

### BRIEF DESCRIPTION OF DRAWINGS

FIG. 1 shows a system for data storage, in accordance with one or more embodiments of the disclosure.

FIG. 2 shows an example of a log-based change data capture, in accordance with one or more embodiments of the disclosure.

FIG. 3 shows a system for data drift detection between data storages, in accordance with one or more embodiments of the disclosure.

FIGS. 4A, 4B, and 4C show examples of a system for data drift detection, in accordance with one or more embodiments of the disclosure.

FIG. 5 shows a flowchart describing a method for detecting data drift between data storages, in accordance with one or more embodiments of the disclosure.

FIG. 6A and FIG. 6B show computing systems, in accordance with one or more embodiments of the disclosure.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the invention. However, it will be apparent to one of ordinary skills in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, although the description includes a discussion of various embodiments of the disclosure, the various disclosed embodiments may be combined in virtually any manner All combinations are contemplated herein.

Embodiments of the disclosure enable a detection of data drift between data storage. Data drift may occur for various reasons, as discussed below, and may have undesirable consequences. Once detected, a data drift may be mitigated, for example, by addressing a discrepancy, by warning a user or administrator, by setting a data drift flag, etc.

As the data is migrated from version 1.0 stack to version 2.0 stack, data parity between both stacks is imperative. To ensure the 2 stacks are in equilibrium, an effective way is needed to guard against divergence of data contents between the source and destination, a phenomenon known as Data Drifting.

Data draft may result in data mismatch between 1.0 and 2.0 databases. One way is when database engineers directly modify the tables when a request is made because of a product bug. These continuously shifting dynamics result in data mismatch between version 1.0 and version 2.0. Without proper monitoring or tools, the unchecked accumulation of these inconsistent data becomes the undesirable “Data Drift”. Data Drift Detection is necessary to help configure and monitor for data changes and report when there is a data drift. The Data Drift Detection should be able to handle records that are changed (added, updated, or deleted) in both version 1.0 or version 2.0 systems as well as all the records that are not changed over a period of time. The drift between version 1.0 and version 2.0 systems for the records that are updated should be detected within a short period of time; for example within 2 hours. The drift between the systems for the records that are not changed should be detected within a reasonable time frame; for example, within 1 month.

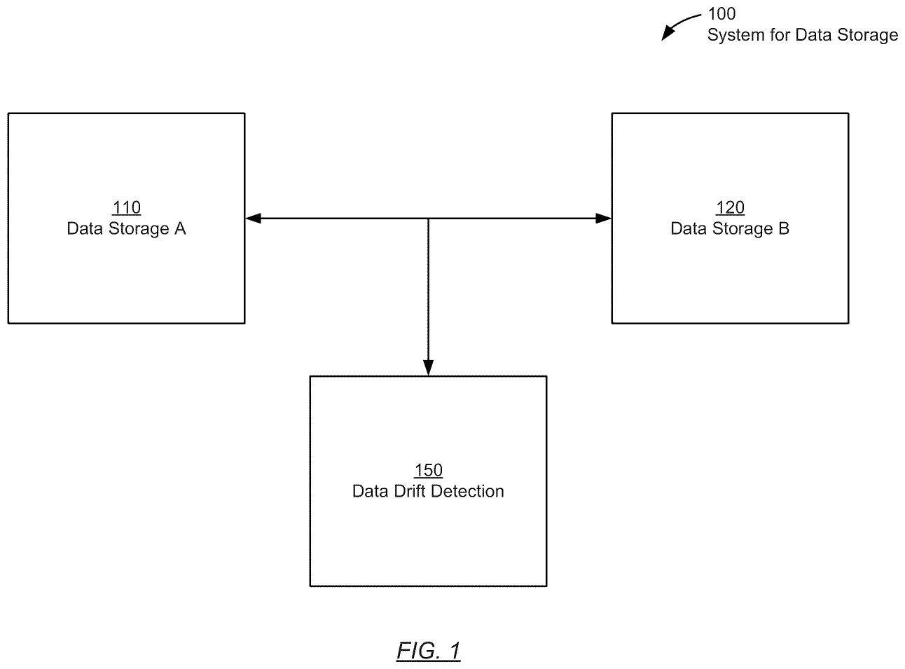

Turning to FIG. 1, a system (100) for data storage, in accordance with one or more embodiments, is shown. The system (100) includes a data storage A (110), a data storage B (120), and a data drift detection engine (150). Each of these components is subsequently described. Additional or fewer components and logic may be included, without departing from the disclosure.

Data storage A (110) and/or data storage B (120) may be any type of data storage such as databases, data warehouses, data lakes, etc. Data storage A (110) and data storage B (120) may be intended to permanently coexist, e.g., to establish a redundant system. Data storage A (110) and data storage B (120) may be intended to temporarily coexist, e.g., for a data migration. Data storage A (110) and data storage B (120) may be of different types, in a heterogenous system. For example, data storage A (110) may be a Structured Query Language (SQL) (relational) database, and data storage B (120) may be a NoSQL (non-relational) database.

In one example configuration, data storage A (110) and data storage B (120) are used to store identity data of customers of a software application. The identity data may include for example, a customer's name, address, date of birth, social security numbers. Data storage A (110) and data storage B (120) may also store other customer-related data such as rules and permissions for using the software application, a user profile, etc. Data storage A (110) and data storage B (120) may store any type of data, without departing from the disclosure. A data migration may be performed from data storage A (110) to data storage B (120). Many motivations may exist for performing such a migration, such as, cost, robustness, performance, etc.

Based on the previously introduced example configuration, assume that both data storage A (110) and data storage B (120) are relational databases (such as SQL) or non-relational databases (such as a noSQL), or a mix of relational and non-relational databases. For example, data storage A (110) may be a relational Oracle database, and data storage B may be a NoSQL DynamoDB database. Further assume that the migration is to be performed from data storage A (110) to data storage B (120). In the example, data storage A (110) may use a complex, monolithic data model, for storing, for example, the identity data, the rules and permission, the user profile, etc. Data storage B (120) may use a simpler but non-monolithic data model, where the identity data, the rules and permissions, and the user profile are separately stored. Accordingly, the data migration from data storage A (110) to data storage B (120) may involve processing of the data to translate between the different data models.

In one or more embodiments, it may be desirable to maintain data parity between data storage A (110) and data storage B (120), i.e., a state in which the data stored in data storage B (120) is identical to the data stored in data storage A (110) even though the format used for strong the data may be different, between data storage A (110) and data storage B (120). Data parity may be desirable regardless of whether data storage A (110) and data storage B (120) are maintained for the purpose of redundancy or for the purpose of data migration between data storage A (110) and data storage B (120) (or vice-versa). Data parity may be maintained if any change (e.g., an addition, deletion, or editing of a record) made to data storage A (110) is similarly applied to data storage B (120) or vice-versa.

Despite these mechanisms for maintaining data parity, data drift may occur between data storage A (110) and data storage B (120). Data drift may occur for various reasons.

One possible reason for data drift is when a record is manually changed in one of the data storages. Consider, for example, a scenario in which a third-party application has a defect and incorrectly writes a record to data storage A (110). Through the data migration, the erroneous record may be propagated to data storage B (120). When the error is detected, an administrator may manually correct the erroneous record in data storage A (110) by replacing the erroneous record with a corrected record. Accordingly, data storage A (110) no longer contains the erroneous record. However, because the record was manually corrected, instead of being written through a data interface that commonly handles all operations associated with data storage A (110), the corrected record is not propagated to data storage B (120). In another scenario, a defect may exist in the code used for the data migration from data storage A (110) to data storage B (120), resulting in an incorrect data migration of a record. Data drift may occur for any reason, without departing from the disclosure. Further, while the above description discusses a data drift occurring in a data migration from data storage A (110) to data storage B (120), the data drift may also occur in a direction from data storage B (120) to data storage A (110).

In one or more embodiments, data drift detection engine (150) is configured to detect the data drift. When data drift is detected, various actions may be taken. For example, an alert may be issued, the cause of the data drift may be isolated, the cause of the data drift may be addressed, etc. Any type of action may be taken in response to the data drift detection, without departing from the disclosure. In one or more embodiments, the data drift detection engine (150) uses a change data capture (CDC) to detect a possible data drift. The CDC may be any type of software and/or hardware configured to detect a change made to the entries in a data source. The CDC may be performed for data storage A (110) to detect changes made to the entries in data storage A, and/or for data storage B (120) to detect changes made to the entries in data storage B. When the CDC indicates a change, the data drift detection (150) may be invoked to determine whether the change has or has not resulted in data drift between data storage A (110) and data storage B (120). Additional details are subsequently discussed.

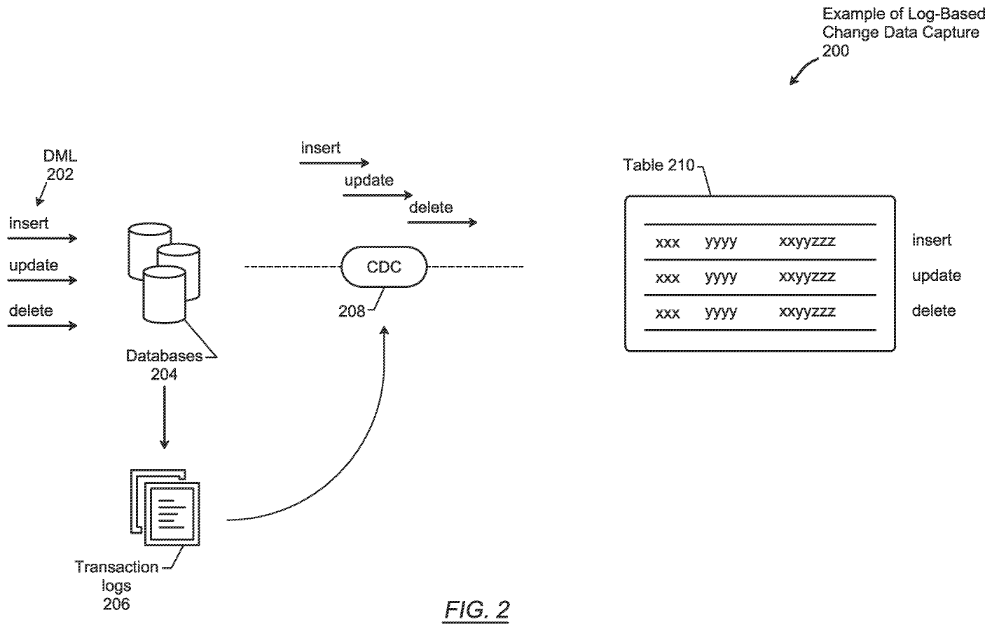

Turning to FIG. 2, an example of a log-based change data capture, in accordance with one or more embodiments of the disclosure, is shown. The example (200) shows a configuration that uses Data Manipulation Language (DML) (202) to update multiple databases (204). The DML (202) may include instructions for inserting, updating, and/or deleting a record (not shown) in the databases (204). A record may be any type of data ranging from a single variable to collection of fields, possibly of different data types. In the previously introduced example, a record may be specific to a customer and may include the customer's name, address, date of birth, social security number, etc. The DML (202) may be provided in Structured Query Language (SQL), if the databases are relational databases. Any other DML may be used, without departing from the disclosure. The DML (202) may be specific to the type of databases (204), or more generally, the type of data storage.

In one or more embodiments, transaction logs (206) store changes made to the databases (204). In case of a CDC (208) that is log-based, the CDC may read the changes from the transaction logs (206). The CDC (208) may output a table (210) indicating changes that were detected, based on the transaction logs (206). The table (210) may identify particular records that have changed and may further identify the type of change. The size of the table (210) depends on the number of changes that were identified. Accordingly, if the CDC (208) is frequently executed, the table (210) may be relatively short, and if the CDC (208) is executed less frequently, the table (210) may be relatively long.

While the output of the CDC (208) is described as a table, the output may be provided in any other format, without departing from the disclosure. Further, while a log-based CDC is provided as an example, any other method for performing a CDC may be used, without departing from the disclosure. For example, a database may use metadata to document changes within the database (e.g., by time-stamping changes within the database). The CDC may, thus, be performed based on the metadata in the database. Many other methods for performing a CDC exist and may be used.

A CDC, e.g., the log-based CDC (200) of FIG. 2, or any other CDC may be implemented for data storage A (110) and for data storage B (120) of FIG. 1. CDC is a process that identifies and tracks changes to data in a database. CDC provides real time or near real time movement of data by moving and processing data continuously as new database events occur. System developers can set up CDC mechanisms in a number of ways and in any one or a combination of system layers from application logic down to physical storage. In a simplified CDC context, one computer system has data believed to have changed from a previous point in time, and a second computer system needs to take action based on that changed data. The former is the source, the latter is the target. It is possible that the source and target are the same system physically, but that would not change the design pattern logically. Multiple CDC solutions can exist in a single system.

Referring to the previously discussed example in which data storage A is a mySQL (relational database, such as Oracle) database, and data storage B is a NoSQL (non-relational database, such as DynamoDB) database, one CDC may be implemented for the Oracle database, and one CDC may be implemented for the DynamoDB database. The CDCs may signal changed records in the Oracle database and in the DynamoDB database, respectively, in a real time or a near real time basis.

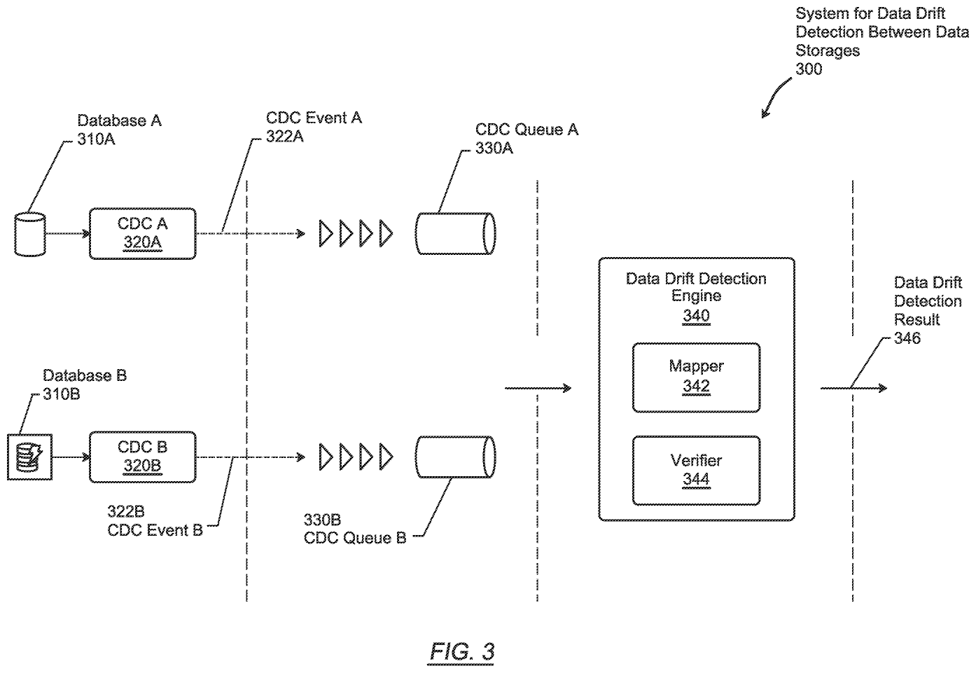

Turning to FIG. 3, a system (300) for data drift detection between data storages, in accordance with one or more embodiments, is shown. The system (300) includes a database A (310A), a database B (310B), a CDC A (320A), a CDC B (320B), a CDC queue A (330A), a CDC queue B (330B), and a data drift detection engine (340). Each of these components is subsequently described.

The system (300) may perform a data drift detection between database A (310A) and database B (310B). Databases A and B (310A, 310B) may be any type of database. Assume, for example, that database A (310A) is a relational Oracle database and that database B (310B) is a non-relational NoSQL DynamoDB database. The disclosure is not limited to these particular types of databases.

A CDC is implemented for each of database A (310A) and database B (310B). CDC A (320A) is specific to database A (310A) and may detect changes made to database A (310A). CDC B (320B) is specific to database B (310B) and may detect changes made to database B (310B). In one or more embodiments, CDC A and CDC B (320A, 320B) detect changes made to the respective databases A and B (310A, 310B), irrespective of whether the changes were invoked by an application or human intervention. Accordingly, any changes made to databases A and B (310A, 310B) may be detected by the respective CDCs (320A, 320B), regardless of whether they are a result of regular operation or manual intervention.

As previously noted, different types of CDC exist. Any type of CDC may be used, without departing from the disclosure. The CDCs (320A, 320B) may identify records that have been added, updated, or deleted in database A (310A) and database B (310B), respectively. A CDC event A (322A) may indicate a change in database A (310A), detected by CDC A (320A). A CDC event B (322B) may indicate a change in database B (310B), detected by CDC B (320B). CDC event A (322A) and CDC event B (322B) may be stored in CDC queues A and B (330A, 330B), respectively, for further processing. In one or more embodiments, a CDC event (e.g., CDC event A or CDC event B (322A, 322B)) points to the record that has been changed, but without necessarily identifying the change in the record. Consider the example of a customer database in which the social security number of a particular customer has been manually corrected. While the resulting CDC event may identify the record associated with the customer, the CDC may not identify the change itself (i.e., that the social security number has changed).

Referring specifically to the example in which database A (310A) is an Oracle database, an event streaming platform (such as Apache Kafka) is used to communicate CDC event A (322A) as a message to be stored under as a topic in CDC queue A (330A), and database B (310B) is a DynamoDB database. In the example, CDC A (320A) may be a component that may be configured to support replication, filtering, transforming, etc. of data between Database A (310A) and Database B (310B). The component uses a series of files (termed trails) to temporarily store detected changes made to Database A (310A). Accordingly, the message with CDC event A (322A) may originate from a trail file of the component. The trail file may store any detected changes ordered by commit time. Trail files may be updated at set time intervals, e.g., hourly. Hourly updates may be a good compromise between having the most current changes in the trail files and avoiding excessive consumption of system resources. Any other time interval may be used, without departing from the disclosure. The communication of the CDC event A (322A) via an event streaming platform message may occur in real-time or near-real time, once the underlying detected change is in a trail file. In one or more embodiments, the event streaming platform topic storing the events communicated as signals using event streaming platform messages may be consumed by the data drift detection engine (340) to perform a data drift detection between databases A and B (310A, 310B), as further discussed below.

A similar configuration that is specific to DynamoDB databases may be used to detect and report changes in database B (310B).

In one or more embodiments, operations performed by the data drift detection engine (340) are triggered by the presence of a CDC event (e.g., a CDC event A (322A) or a CDC event B (322B) in CDC queue A or CDC queue B (330A, 330B), respectively).

In one or more embodiments, an event in a CDC queue points to a record that has changed, in the corresponding database. For example, a CDC event A (322A) stored in CDC queue A (330A) may include an identifier of a record that has been changed in database A (310A). The data drift detection engine (340), in one embodiment accesses the record in database A (310A), using the identifier. In one embodiment, the data drift detection engine (340) further accesses the corresponding record in database B (310B). In one embodiment, a comparison of the record accessed in database A (310A) and the corresponding record in database B (310B) is subsequently performed. Because database A (310A) and database B (310B) may be different types of databases, the data model user for storing the record in database A (310A) and the data model used for storing the corresponding record in database B (310B) may be different.

In one embodiment, a mapper (342) uses a library to map the record accessed in database A (310A) from the data model of database A (310A) to the data model of database B (310B) to enable a direct comparison. Alternatively, the comparison may be performed using the data model of database A (310) by mapping the corresponding record accessed in database B (310B) from the data model of database B (310B) to the data model of database A (310A).

In one or more embodiments, the verifier (344) performs a comparison of the record with the corresponding record, after the mapping by the mapper (342). If a difference between the record and the corresponding record is found, the data drift detection result (346) is that data drift between the record and the corresponding record exists. Additional information may be provided. For example, the record with the change may be identified, and/or the actor invoking the change may be identified.

Alternatively, if no difference between the record and the corresponding record is found, the data drift detection result (346) is that no data drift exists between the record and the corresponding record.

Upon enabling a mastering of a percentage of users in version 2.0, the data verification will continue as part of a process where synchronization back to version 1.0 occurs. In addition to the synchronization back and verification, which checks for data parity between the version 1.0 and version 2.0 stack, a scheduled verification process is enabled. The goal of the scheduled verification process is to trigger a bulk verification in case Oracle Management Service (OMS) messages are lost and not processed due to various failure points in the synchronization back process.

While operations performed in response to a CDC event A (322A) stored in CDC queue A (330A) have been described, similar operations may be performed in response to a CDC event B (322B) stored in CDC queue B (330B).

If the data drift detection result (346) indicates that data drift has been detected, various actions may be triggered. For example, notifications may be issued, certain operations such as ongoing migration may be put on hold to avoid further deterioration in data quality and introduce additional complexity to data reconciliation, etc.

While FIG. 1, FIG. 2, and FIG. 3 show configurations of components, other configurations may be used without departing from the scope of the disclosure. For example, various components may be combined to create a single component. As another example, the functionality performed by a single component may be performed by two or more components that may be communicatively connected using a network connection. The systems of FIG. 1 and FIG. 3 may include additional components for propagating changes made to one database to other databases. These additional components may successfully propagate changes between the databases under most circumstances, while the data drift detection identifies cases in which the propagation of changes between the databases has been unsuccessful, e.g., due to code errors, manual intervention, etc., as previously discussed.

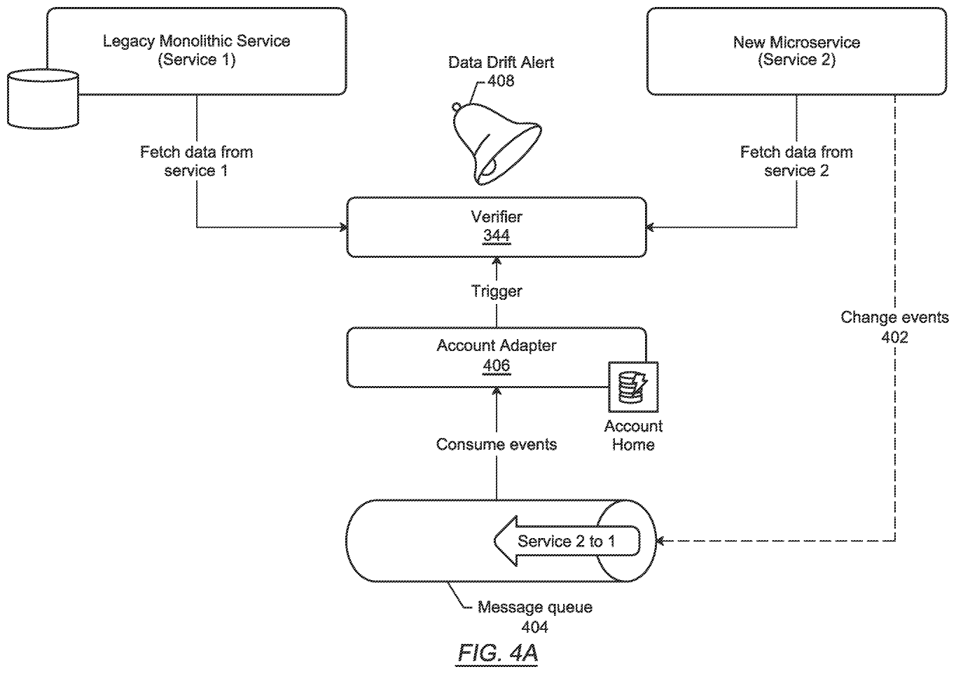

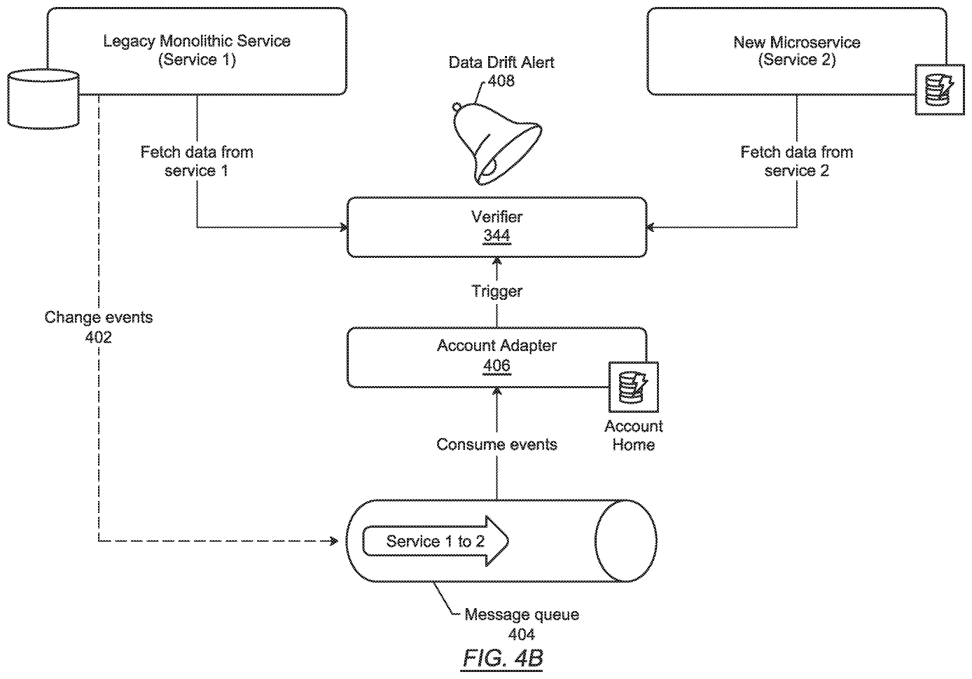

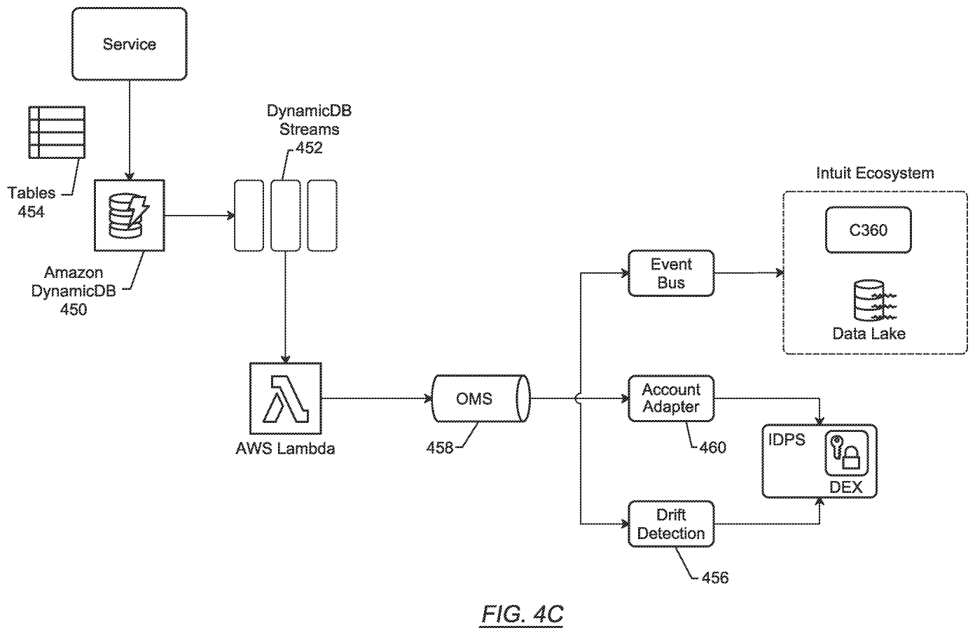

FIG. 4A shows an example of a data verification process of change events (402) from a New Microservice (Service 2). The change events (402) travel from Service 2 and are added to a message queue (404). The change events (402) are then consumed by the account adapter (406), which is triggered to feed the change events (402) into the verifier (344). As described above and shown in FIG. 4A, the verifier (344) takes as input data fetched from both Legacy Monolithic Service (Service 1) and Service 2. This input data is then verified, as outlined above, based on the event passed from Service 2 and then up to the verifier (344). If data drift is identified by the verifier (344), a data drift alert (408) is activated to signal data divergence. Alternatively, if no data draft is identified based on the event, the no data drift alert (408) is activated.

FIG. 4B shows an example of a data verification process of change events (402) from a Legacy Monolithic Service (Service 1). The change events (402) travel from Service 1 and are added to a message queue (404). The change events (402) are then consumed by the account adapter (406), which is triggered to feed the change events (402) into the verifier (344). As described above and shown in FIG. 4B, the verifier (344) takes as input data fetched from both Service 1 and New Microservice (Service 2). This input data is then verified, as outlined above, based on the event passed from Service 1 and then up to the verifier (344). If data drift is identified by the verifier (344), a data drift alert (408) is activated to signal data divergence. Alternatively, if no data draft is identified based on the event, the no data drift alert (408) is activated.

FIG. 4C shows an example approach for extracting changes from the DynamoDB (450) and the components necessary to accomplish the example approach. As shown, when DynamoDB Streams (452) feature is enabled, it captures a time-ordered sequence of item-level modifications in a DynamoDB table (454) and durably stores the information for up to 24 hours. The drift detection (456) is a consumer to OMS messages (458). The drift detection job consumes the OMS messages (458) and processes them at a configurable time interval. For example, in one or more embodiments, the messages in drift detection (456) are processed on an hourly basis. This frequency allows the drift detection job to be running at a different frequency than the Account Adapter (460) sync back to 1.0 consumer.

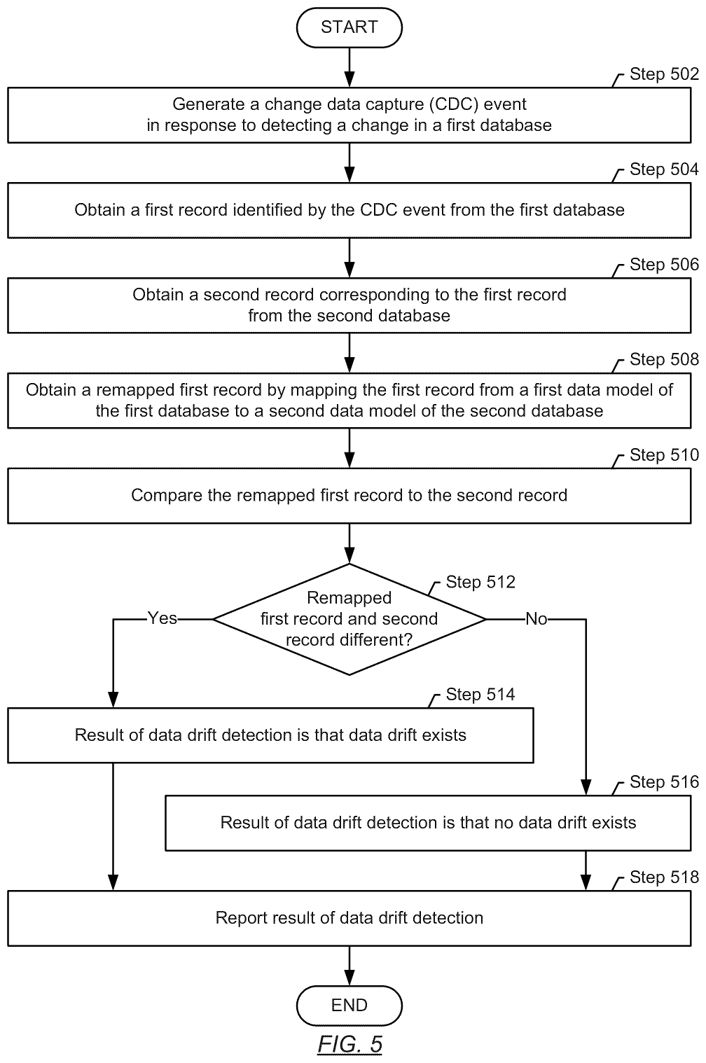

FIG. 5 shows a flowchart in accordance with one or more embodiments. The flowchart of FIG. 5 depicts a method for detecting data drift between data storages. One or more of the steps in FIG. 5 may be performed by various components of the systems, previously described in reference to at least FIG. 1, FIG. 2, and FIG. 3.

While the various steps in these flowcharts are presented and described sequentially, one of ordinary skill will appreciate that some or all of the steps may be executed in different orders, may be combined or omitted, and some or all of the steps may be executed in parallel. Additional steps may further be performed. Furthermore, the steps may be performed actively or passively. For example, some steps may be performed using polling or be interrupt driven in accordance with one or more embodiments of the disclosure. By way of an example, determination steps may not require a processor to process an instruction unless an interrupt is received to signify that condition exists in accordance with one or more embodiments of the disclosure. As another example, determination steps may be performed by performing a test, such as checking a data value to test whether the value is consistent with the tested condition in accordance with one or more embodiments of the disclosure. Accordingly, the scope of the disclosure should not be considered limited to the specific arrangement of steps shown in FIG. 5.

Broadly speaking, the method shown in FIG. 5 may be executed to determine whether a change made to a record in one database has not been propagated to other databases. Variations of the method may accommodate different scenarios, including the operation on individual records, triggered by a change data capture, but also batch operation on larger sets of records to confirm parity between databases, even in absence of a trigger by a change data capture. The method may be executed at a higher frequency, e.g., every few hours, for records which have been changed. A batch execution for records with no known changes may be performed less frequently, for example once per month.

In Step 502, a CDC event is generated in response to detecting a change in a first database. In one or more embodiments, the CDC identifies and captures data that has been added, updated, or deleted from the relational table(s), and therefore provides a very specific trigger to kick off the data parity verification process of the version 1 stack database and version 2 stack database. In Step 504, a first record identified by the CDC event is obtained from the first database. In Step 506, a second record corresponding to the first record is obtained from the second database.

In Step 508, a remapped first record is obtained by mapping the first record from a first data model of the first database to a second data model of the second database. In Step 510, the remapped first record is compared to the second record. In one or more embodiments of the disclosure, an account adaptor listens to the CDC events, extracts the authentication event of the account, and orchestrates the data verification process.

In Step 512, inquire whether the remapped first record and the remapped second record are different. In Step 514, if yes, then the result of data drift detection is that data drift exists. In Step 516, if no, then the result of data drift detection is that no data drift exists.

In Step 518, upon determining whether data drift exists (or not) the result of data drift detection is reported. In particular, observability dashboards may be used to monitor the data drift. Alternatively, the reporting of data drift is through graphical user interface, text messages, email messages, alerts within the management tool, etc. Moreover, alerts are fired when data divergence is detected and triggers a circuit breaker for the offline migration process to avoid further deterioration in data quality and introduce additional complexity to data reconciliation.

In one or more embodiments, the process shown and described in relation to FIG. 5 meets the following requirements:
1. Identify and report the differences between data found in version 1.0 stack and version 2.0 stack;
2. Both version 1.0 stack and version 2.0 stack updates trigger a data comparison;
3. Scan the entire dataset and validate the data parity where the entire dataset can be grouped into multiple segments and the scan runs for a segment;
4. Detect any discrepancies for the records that are recently changed soon after the change and detect any discrepancies for the entire dataset within a reasonable timeframe; and
5. Identify and automate detection of false positives.

Various embodiments of the disclosure have one or more of the following advantages. Embodiments of the disclosure enable a detection of data drift between databases. Frequently, providers of database solutions do not have an interest in providing solutions for the detection of data drift for heterogeneous database configurations, because it may be counter to their business interests to encourage or facilitate use of alternative database solutions. Embodiments of the disclosure enable the detection of data drift in heterogeneous database configurations. Embodiments of the disclosure are further suitable to operate bidirectionally, i.e., a detection of data drift may be performed for both of two databases that are synchronized. Embodiments of the disclosure may operate on a single record for which a change has been detected. Embodiments of the disclosure may also operate on sets of record (or even an entire database) regardless of whether changes have been detected. Embodiments of the disclosure allow for data drift detection to detect data changes in the relational database that may be triggered by the application, manual SQL interactions, e.g., data fixes or other operations. Embodiments of the disclosure allow for data drift detection to identify the account being changed and ideally the actor invoking the changes. Embodiments of the disclosure do not add significant computational overhead to a database configuration. Specifically, for example, embodiments of the disclosure may rely on a message queue (CDC queue) that may already exist in many database configurations.

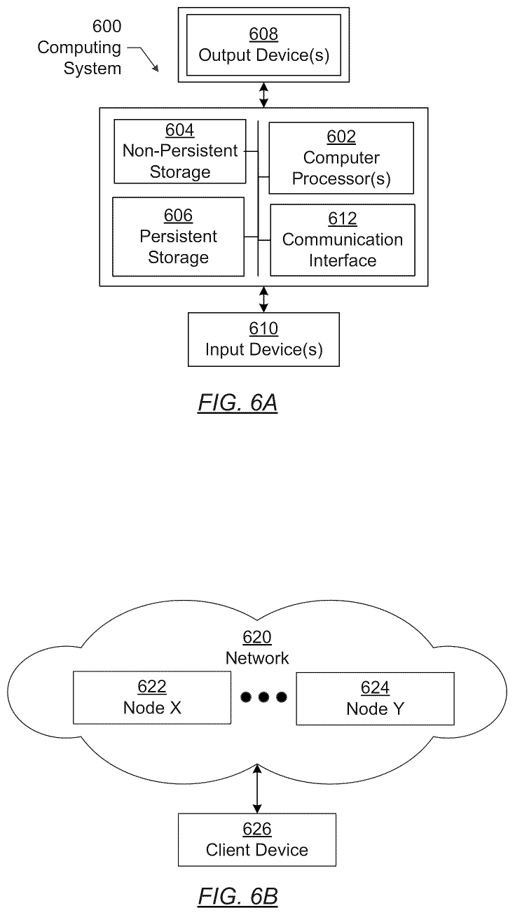

Embodiments of the disclosure may be implemented on a computing system. Any combination of mobile, desktop, server, router, switch, embedded device, or other types of hardware may be used. For example, as shown in FIG. 6A, the computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), and numerous other elements and functionalities.

The computer processor(s) (602) may be an integrated circuit for processing instructions. For example, the computer processor(s) may be one or more cores or micro-cores of a processor. The computing system (600) may also include one or more input devices (610), such as a touchscreen, keyboard, mouse, microphone, touchpad, electronic pen, or any other type of input device.

The communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

Further, the computing system (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (600) in FIG. 6A may be connected to or be a part of a network. For example, as shown in FIG. 6B, the network (620) may include multiple nodes (e.g., node X (622), node Y (624)). Each node may correspond to a computing system, such as the computing system shown in FIG. 6A, or a group of nodes combined may correspond to the computing system shown in FIG. 6A. By way of an example, embodiments of the disclosure may be implemented on a node of a distributed system that is connected to other nodes. By way of another example, embodiments of the disclosure may be implemented on a distributed computing system having multiple nodes, where each portion of the invention may be located on a different node within the distributed computing system. Further, one or more elements of the aforementioned computing system (600) may be located at a remote location and connected to the other elements over a network.

Although not shown in FIG. 6B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (622), node Y (624)) in the network (620) may be configured to provide services for a client device (626). For example, the nodes may be part of a cloud computing system. The nodes may include functionality to receive requests from the client device (626) and transmit responses to the client device (626). The client device (626) may be a computing system, such as the computing system shown in FIG. 6A. Further, the client device (626) may include and/or perform all or a portion of one or more embodiments of the disclosure.

The computing system or group of computing systems described in FIG. 6A and FIG. 6B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establish a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system in FIG. 6A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 6A, while performing one or more embodiments of the disclosure, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 6A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g., join, full join, count, average, etc.), sort (e.g., ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 6A may include functionality to present raw and/or processed data, such as results of comparisons and other processing. For example, presenting data may be accomplished through various presentation methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 6A and the nodes and/or client device in FIG. 6B. Other functions may be performed using one or more embodiments of the disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for detecting data drift between a first database and a second database, comprising:
obtaining, from the first database, and based on a change data capture (CDC) event generated in response to a change detected in the first database, a first record identified by the CDC event;
obtaining, from the second database, a second record corresponding to the first record;
obtaining a remapped first record by mapping the first record from a first data model of the first database to a second data model of the second database;
comparing the remapped first record to the second record;
determining, based on comparing, that a data drift exists, wherein the data drift comprises a difference between the first record and the second record; and
mitigating the data drift by transforming a data structure of the first record from the first database to the data structure of the second database to generate a transformed record.

2. The method of claim 1 wherein the first database and the second database are executing on a plurality of different technologies and persist data in a plurality of different models.

3. The method of claim 1, further comprising:
performing differential analysis between the transformed record from the first database and the record from the second database to enable comparison.

4. The method of claim 1, wherein data drift is reported using an observability dashboard.

5. The method of claim 1, wherein data drift is reported using an alert fired when data divergence is detected.

6. The method of claim 1, wherein data drift triggers a circuit breaker for an offline migration process to avoid further deterioration in data quality.

7. The method of claim 1, further comprising:
performing CDC to identify and track changes to data in the first database.

8. The method of claim 1, wherein CDC provides real time or near real time movement of data by moving and processing data continuously as new database events occur.

9. The method of claim 1, wherein the CDC comprises a plurality of CDC solutions existing in a single system.

10. The method of claim 1, further comprising:
performing CDC to identify and track changes to data in the second database.

11. A system for detecting data drift detection between a first database and a second database, comprising:
a computer processor; and
a data drift detection engine executing on the computer processor configured to:
obtain, from the first database, and based on a change data capture (CDC) event generated in response to a change detected in the first database, a first record identified by the CDC event;
obtain, from the second database, a second record corresponding to the first record;
obtain a remapped first record by mapping the first record from a first data model of the first database to a second data model of the second database;
compare the remapped first record to the second record;
determine, based on comparing, that a data drift exists, wherein the data drift comprises a difference between the first record and the second record; and
mitigating the data drift by transforming a data structure of the first record from the first database to the data structure of the second database to generate a transformed record.

12. The system of claim 11, further comprising:
a mapper configured to map a first record accessed in a first database from a data model of the first database to a data model of the second database to enable a direct comparison.

13. The system of claim 11, further comprising:
a verifier configured to perform a comparison of the first record with the second record.

14. The system of claim 11, further comprising:
a plurality of transaction logs configured to store changes made to a plurality of databases.

15. The system of claim 11, further comprising:
a change data capture (CDC) configured to detect a change made to entries in a data source.

16. The system of claim 11, wherein the first database and the second database are executing on a plurality of different technologies and persist data in a plurality of different models.

17. The system of claim 11, wherein the data drift detection engine executing on the computer processor further configured to:
perform differential analysis between the transformed record from the first database and the record from the second database to enable comparison.

18. The system of claim 11, wherein data drift is reported using an alert fired when data divergence is detected.

19. The system of claim 11, wherein data drift triggers a circuit breaker for an offline migration process to avoid further deterioration in data quality.

20. A non-transitory computer readable medium comprising instruction for execution on a computer processor to perform:
obtaining, from a first database, and based on a change data capture (CDC) event generated in response to a change detected in the first database, a first record identified by the CDC event;
obtaining, from a second database, a second record corresponding to the first record;
obtaining a remapped first record by mapping the first record from a first data model of the first database to a second data model of the second database;
comparing the remapped first record to the second record;
determining, based on comparing, that a data drift exists, wherein the data drift comprises a difference between the first record and the second record; and
mitigating the data drift by transforming a data structure of the first record from the first database to the data structure of the second database to generate a transformed record.
